(19) United States
(12) Patent Application Publication
(10) Pub. No.: US 2025/0297895 A1
(43) Pub. Date: Sep. 25, 2025

(54) SENSOR APPARATUS

(71) Applicant: TDK Corporation, Tokyo (JP)

(72) Inventors: Tadao SENRIUCHI, Tokyo (JP); Shinji HARA, Tokyo (JP); Naoki OHTA, Tokyo (JP); Susumu AOKI, Tokyo (JP)

(73) Assignee: TDK Corporation, Tokyo (JP)

(21) Appl. No.: 19/059,584

(22) Filed: Feb. 21, 2025

(30) Foreign Application Priority Data
Mar. 19, 2024 (JP) 2024-043534

(51) Int. Cl. G01J 5/22; G01J 5/20; G01J 5/48

(52) U.S. Cl. CPC G01J 5/22; G01J 5/48; G01J 2005/202

(57) ABSTRACT

A sensor apparatus includes an element array circuit and a control circuit. The element array circuit includes first wirings, second wirings, and impedance elements. The second wirings each extend in a direction different from a direction in which the first wirings each extend. The impedance elements are each coupled to both one of the first wirings and one of the second wirings. The control circuit is configured to, based on at least two of output voltages each resulting from corresponding one of correction impedance elements, among the impedance elements, that are coupled to one first correction wiring selected from the first wirings, correct an output voltage resulting from at least one of measurement impedance elements, among the impedance elements, that are coupled to one first measurement wiring that is selected from the first wirings and other than the first correction wiring.

### CROSS-REFERENCE TO RELATED APPLICATIONS

The present application claims priority from Japanese Patent Application No. 2024-043534 filed on Mar. 19, 2024, the entire contents of which are hereby incorporated by reference.

### BACKGROUND

The disclosure relates to a sensor apparatus including an element array circuit that includes an element array in which multiple impedance elements are arranged.

A resistor array circuit has been proposed that includes multiple resistors arranged in a matrix. Such a resistor array circuit is used as, for example, an infrared detection circuit. For example, reference is made to Japanese Unexamined Patent Application Publication No. H08-094443. Such an infrared detection circuit includes infrared-sensitive resistors arranged therein. Examples of the infrared-sensitive resistors may include a thermistor whose resistance value changes with changing temperature.

### SUMMARY

A sensor apparatus according to one embodiment of the disclosure includes an element array circuit and a control circuit. The element array circuit includes first wirings, second wirings, and impedance elements. The second wirings each extend in a direction different from a direction in which the first wirings each extend. The impedance elements are each coupled to both one of the first wirings and one of the second wirings. The control circuit is configured to, based on at least two of output voltages each resulting from corresponding one of correction impedance elements, among the impedance elements, that are coupled to one first correction wiring selected from the first wirings, correct an output voltage resulting from at least one of measurement impedance elements, among the impedance elements, that are coupled to one first measurement wiring that is selected from the first wirings and other than the first correction wiring.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a circuit diagram illustrating a configuration example of a sensor apparatus according to one example embodiment of the disclosure.

FIG. 2 is a characteristic diagram schematically illustrating a relationship between a position of a node and a potential at the position of the node in an element array circuit illustrated in FIG. 1.

FIG. 3 is an explanatory diagram illustrating a relationship between an increase in the number of resistors coupled in parallel and an increase in a drop voltage in the element array circuit illustrated in FIG. 1.

FIG. 4 is a flowchart describing an example of a measurement operation to be performed by the sensor apparatus illustrated in FIG. 1.

FIG. 5A is a first explanatory diagram describing the example of the measurement operation to be performed by the sensor apparatus illustrated in FIG. 1.

FIG. 5B is a second explanatory diagram describing the example of the measurement operation to be performed by the sensor apparatus illustrated in FIG. 1.

FIG. 6 is a circuit diagram illustrating a configuration example of a sensor apparatus according to one example embodiment of the disclosure.

FIG. 7 is a circuit diagram illustrating a configuration example of a sensor apparatus according to one example embodiment of the disclosure.

### DETAILED DESCRIPTION

High measurement accuracy for a physical quantity targeted for measurement is demanded of a sensor apparatus with an element array circuit including sensor elements.

It is desirable to provide a sensor apparatus that achieves high measurement accuracy for a physical quantity targeted for measurement.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings. Note that the description is given in the following order.
1. First example embodiment: an example of a sensor apparatus with a first element array circuit including power feeding lines, readout lines, and operational amplifiers
2. Second example embodiment: an example of a sensor apparatus with a second element array circuit including power feeding lines, readout lines, and operational amplifiers
3. Third example embodiment: an example of a sensor apparatus with a third element array circuit including power feeding lines, readout lines, operational amplifiers, and an electromagnetic shield

### 4. Modification Examples

### 1. First Example Embodiment

### Overall Configuration Example of Sensor Apparatus

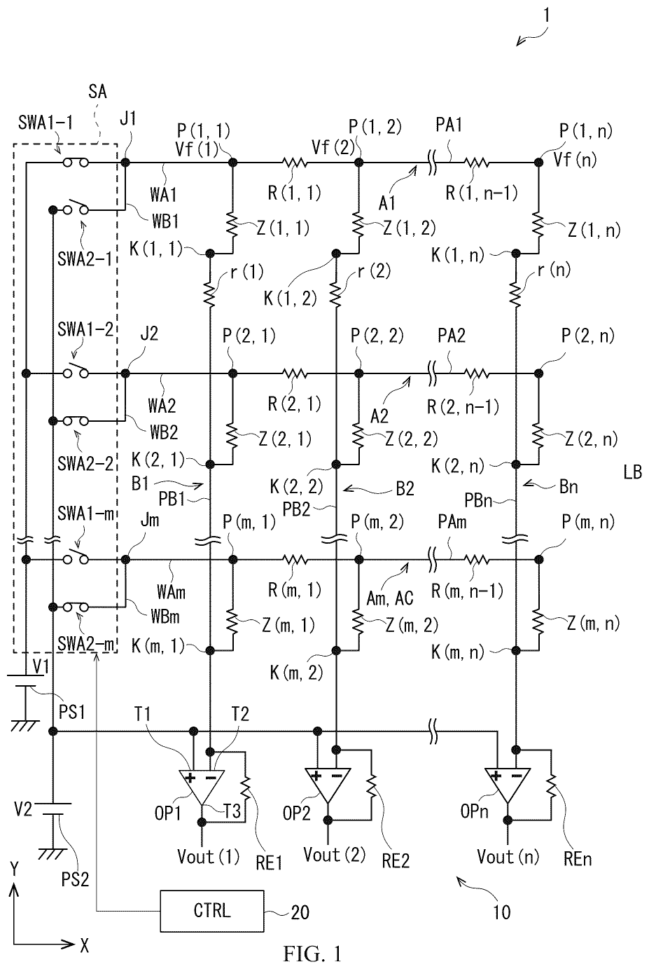

FIG. 1 is a circuit diagram schematically illustrating a configuration example of a sensor apparatus 1 according to a first example embodiment of the disclosure. The sensor apparatus 1 includes an element array circuit 10 and a control circuit 20, for example. The element array circuit 10 may be mountable on, for example, an electromagnetic wave sensor (e.g., an infrared thermography) that detects electromagnetic waves such as infrared rays, and may be configured to output an output voltage corresponding to an intensity of the electromagnetic waves, such as infrared rays, applied to the element array circuit 10. The element array circuit 10 may perform a measurement operation in accordance with a command from the control circuit 20.

As illustrated in FIG. 1, the element array circuit 10 may include, for example, power feeding lines A denoted as A1 to Am in FIG. 1, readout lines B denoted as B1 to Bn in FIG. 1, resistors Z denoted as Z (1, 1) to Z (m, n) in FIG. 1, operational amplifiers OP denoted as OP1 to OPn in FIG. 1, resistors RE denoted as RE1 to REn in FIG. 1, and a power feeding line selector SA. In FIG. 1, “m” power feeding lines A are provided by way of example, and the number “m” of the power feeding lines A may be freely chosen from among integers of two or more. Similarly, in FIG. 1, “n” readout lines B are provided by way of example, and the number “n” of the readout lines B may be freely chosen from among integers of two or more. In FIG. 1, one resistor Z coupled to both an “a”-th power feeding line Aa of the “m” power feeding lines A1 to Am and a “b”-th readout line Bb of the “n” readout lines B1 to Bn is denoted as Z (a, b), where “a” is a natural number less than or equal to “m”, and “b” is a natural number less than or equal to “n”. The same applies to the drawings subsequent to FIG. 1. The power feeding lines A and the readout lines B may not be in direct contact with each other. In FIG. 1, a node P between the “a”-th power feeding line Aa of the “m” power feeding lines A1 to Am and the resistor Z (a, b) is denoted as P (a, b). Further, in FIG. 1, a node K between the “b”-th readout line Bb of the “n” readout lines B1 to Bn and the resistor Z (a, b) is denoted as K (a, b).

[Power feeding line A]

The power feeding lines A may correspond to a specific but non-limiting example of “first wirings” in one embodiment of the disclosure.

The power feeding lines A (A1 to Am in FIG. 1) may each be a conductor extending from a direct-current power supply PS1 described later to a node P (a, n). The power feeding lines A may include respective first parts PA (denoted as PA1 to PAm in FIG. 1) each extending in a first direction. The first parts PAI to PAm may each be a part of corresponding one of the power feeding lines A1 to Am. The first parts PA may be arranged to be adjacent to each other in a second direction different from the first direction. In the example embodiment illustrated in FIG. 1, “m” first parts PA may each extend in an X-axis direction and may be arranged to be adjacent to each other in a Y-axis direction orthogonal to the X-axis direction. The first part PAI may be a part from a node P (1, 1) to a node P (1, n) in the power feeding line A1. The first part PA2 may be a part from a node P (2, 1) to a node P (2, n) in the power feeding line A2. The first part PAm may be a part from a node P (m, 1) to a node P (m, n) in the power feeding line Am. Thus, the first part PAa may be a part from a node P (a, 1) to the node P (a, n) in the power feeding line Aa. In other words, the first parts PA may each be a part, of corresponding one of the power feeding lines A, to which multiple ones of the resistors Z are coupled.

As illustrated in FIG. 1, the power feeding lines A (A1 to Am) may each have a first end coupled to the direct-current power supply PS1. The power feeding lines A (A1 to Am) may further include respective coupling parts WA denoted as WA1 to WAm in FIG. 1. In the power feeding line A1, a part from the direct-current power supply PS1 to the node P (1, 1) may be the coupling part WA1. In the power feeding line A2, a part from the direct-current power supply PS1 to the node P (2, 1) may be the coupling part WA2. In the power feeding line Am, a part from the direct-current power supply PS1 to the node P (m, 1) may be the coupling part WAm. Thus, the coupling part WAa may be a part from the direct-current power supply PS1 to the node P (a, 1) in the power feeding line Aa. Further, respective coupling wirings WB denoted as WB1 to WBm in FIG. 1 may be coupled to the coupling parts WA (WA1 to WAm). For example, a second end of the coupling wiring WB1 may be coupled to the coupling part WA1 at a node J1; a second end of the coupling wiring WB2 may be coupled to the coupling part WA2 at a node J2; and a second end of the coupling wiring WBm may be coupled to the coupling part WAm at a node Jm. Thus, the second end of the coupling wiring WBa may be coupled to the coupling part WAa at a node Ja. Note that the second end of the coupling wiring WBa may be coupled to the coupling part WAa at the node P (a, 1). In other words, the node Ja and the node P (a, 1) may be coincident with each other. Further, a first end of the coupling wiring WBa opposite to the second end may be coupled to a direct-current power supply PS2. As illustrated in FIG. 1, the coupling parts WA (WA1 to WAm) may share their respective portions. In some embodiments, the coupling parts WA (WA1 to WAm) may be independent of each other and individually coupled to the direct-current power supply PS1. The direct-current power supply PS1 may be provided inside the element array circuit 10 or outside the element array circuit 10. Similarly, the direct-current power supply PS2 may be provided inside the element array circuit 10 or outside the element array circuit 10. A voltage is applicable from the direct-current power supply PS1 to the first end of each of the power feeding lines A (A1 to Am) to cause the first end of each of the power feeding lines A (A1 to Am) to be at a first potential V1. A voltage is applicable from the direct-current power supply PS2 to the first end of each of the coupling wirings WB (WB1 to WBm) to cause the first end of each of the coupling wirings WB (WB1 to WBm) to be at a second potential V2.

Corresponding one of switches SWA1 (SWA1-1 to SWA1-m) may be provided at a point between the direct-current power supply PS1 and the node P (a, 1) on the power feeding line Aa. For example, the switch SWA1-1 may be provided at a point between the direct-current power supply PS1 and the node P (1, 1) on the power feeding line A1; the switch SWA1-2 may be provided at a point between the direct-current power supply PS1 and the node P (2, 1) on the power feeding line A2; and the switch SWA1-m may be provided at a point between the direct-current power supply PS1 and the node P (m, 1) on the power feeding line Am. Further, corresponding one of switches SWA2 (SWA2-1 to SWA2-m) may be provided on the coupling wiring WBa. For example, the switch SWA2-1 may be provided on the coupling wiring WB1; the switch SWA2-2 may be provided on the coupling wiring WB2; and the switch SWA2-m may be provided on the coupling wiring WBm.

To each of the power feeding lines A, multiple ones of the resistors Z may be coupled at their respective first ends. In the example embodiment illustrated in FIG. 1, “n” resistors Z may be coupled in parallel to each of the “m” power feeding lines A. In one example, the resistors Z (1, 1) to Z (1, n) may be coupled at their respective first ends to the power feeding line A1 extending in the X-axis direction. For example, the power feeding line A1 and the resistor Z (1, 1) may be coupled to each other at the node P (1, 1). The power feeding line A1 and the resistor Z (1, 2) may be coupled to each other at the node P (1, 2). The power feeding line A1 and the resistor Z (1, n) may be coupled to each other at the node P (1, n). Thus, a “b”-th resistor Z (1, b) from the node P (1, 1) may be coupled to the power feeding line A1 at a “b”-th node P (1, b) from the node P (1, 1).

Similarly, the resistors Z (2, 1) to Z (2, n) may be coupled at their respective first ends to the power feeding line A2 extending in the X-axis direction. For example, the power feeding line A2 and the resistor Z (2, 1) may be coupled to each other at the node P (2, 1). The power feeding line A2 and the resistor Z (2, 2) may be coupled to each other at the node P (2, 2). The power feeding line A2 and the resistor Z (2, n) may be coupled to each other at the node P (2, n). Thus, a “b”-th resistor Z (2, b) from the node P (2, 1) may be coupled to the power feeding line A2 at a “b”-th node P (2, b) from the node P (2, 1).

Further, the resistors Z (m, 1) to Z (m, n) may be coupled at their respective first ends to the power feeding line Am extending in the X-axis direction. For example, the power feeding line Am and the resistor Z (m, 1) may be coupled to each other at the node P (m, 1). The power feeding line Am and the resistor Z (m, 2) may be coupled to each other at the node P (m, 2). The power feeding line Am and the resistor Z (m, n) may be coupled to each other at the node P (m, n). Thus, a “b”-th resistor Z (m, b) from the node P (m, 1) may be coupled to the power feeding line Am at a “b”-th node P (m, b) from the node P (m, 1).

In this way, the resistors Z (a, 1) to Z (a, n) may be coupled at their respective first ends to the power feeding line Aa extending in the X-axis direction. In the example embodiment illustrated in FIG. 1, the resistors Z (1, n) to Z (m, n) arranged in the Y-axis direction may be respectively coupled at their first ends to the nodes P (1, n) to P (m, n) that are respective second ends of the “m” power feeding lines A opposite to the respective first ends of the “m” power feeding lines A.

### [Power Feeding Line Selector SA]

The power feeding line selector SA may include the switches SWA1 (SWA1-1 to SWA1-m) and the switches SWA2 (SWA2-1 to SWA2-m). The switches SWA1 (SWA1-1 to SWA1-m) and the switches SWA2 (SWA2-1 to SWA2-m) may each be switchable between a conducting state and a nonconducting state. The switches SWA1 (SWA1-1 to SWA1-m) may each be provided at the point between the direct-current power supply PS1 and the node P (a, 1) on corresponding one of the power feeding lines Aa. The switches SWA2 (SWA2-1 to SWA2-m) may each be provided on corresponding one of the coupling wirings WB (WB1 to WBm).

The power feeding line selector SA may select one power feeding line A from the power feeding lines A. For convenience, the one power feeding line A selected from the power feeding lines A will be referred to as a selected power feeding line AS. The power feeding line selector SA may couple the first part PA of the selected power feeding line AS to the direct-current power supply PS1 and couple the first parts PA of all of the power feeding lines A other than the selected power feeding line AS to the direct-current power supply PS2. For convenience, the power feeding lines A other than the selected power feeding line AS will each be referred to as an unselected power feeding line AU. A voltage may be applied to the first end of the selected power feeding line AS by the direct-current power supply PS1 to cause the first end of the selected power feeding line AS to be at the first potential V1. Note that the selected power feeding line AS may suffer a drop in voltage due to a wiring resistance of the selected power feeding line AS and a current flowing through the selected power feeding line AS. A voltage may be applied to the first parts PA of the unselected power feeding lines AU by the direct-current power supply PS2 to cause the first parts PA of the unselected power feeding lines AU to be at the second potential V2. The second potential V2 may be different from the first potential V1. The potential at the first part PA of the selected power feeding line AS may be different from the potential (i.e., the second potential V2) at the first parts PA of the unselected power feeding lines AU. The operation of the power feeding line selector SA may be controlled by the control circuit 20. For example, respective switching operations of the switches SWA1 (SWA1-1 to SWA1-m) and respective switching operations of the switches SWA2 (SWA2-1 to SWA2-m) may be executed based on commands from the control circuit 20.

### [Control Circuit 20]

The control circuit 20 may include a microcomputer, for example. The control circuit 20 may execute predetermined control processing by causing a central processing unit (CPU) to execute a control program. The control circuit 20 may control, for example, the switching operations of the switches SW.

In one example, the control circuit 20 may control switching operations of the power feeding line selector SA. For example, the control circuit 20 may set one switch SWA1 corresponding to the selected power feeding line AS to the conducting state and set the other switches SWA1 corresponding to the unselected power feeding lines AU to the nonconducting state. In addition, the control circuit 20 may set one switch SWA2 corresponding to the selected power feeding line AS to the nonconducting state and set the other switches SWA2 corresponding to the unselected power feeding lines AU to the conducting state. Here, the selected power feeding line AS may be one power feeding line A corresponding to a selected resistor ZS described below. The unselected power feeding lines AU may be all the power feeding lines A except the selected power feeding line AS.

The control circuit 20 may measure an output voltage corresponding to each of the resistors Z in the element array circuit 10. As used herein, one resistor Z selected from the resistors Z and coupled to both the selected power feeding line AS and one of the readout lines B will be referred to as the selected resistor ZS, for convenience. For example, the control circuit 20 may measure an output voltage that results from the selected resistor ZS and that is outputted from an output terminal T3 of one operational amplifier OP corresponding to the one of the readout lines B corresponding to the selected resistor ZS. In performing the measurement, the control circuit 20 corrects the output voltage resulting from at least one of the resistors Z, as described below. As used herein, one power feeding line A for correction that is selected from the power feeding lines A will be referred to as a correction power feeding line AC, for convenience. One power feeding line A for measurement that is selected from the power feeding lines A and other than the correction power feeding line AC will be referred to as a measurement power feeding line AM, for convenience. Of the resistors Z, multiple resistors Z for correction that are coupled to the correction power feeding line AC will be referred to as correction resistors ZC, for convenience. Of the resistors Z, multiple resistors Z coupled to the measurement power feeding line AM will be referred to as measurement resistors ZM, for convenience. The control circuit 20 corrects the output voltage resulting from at least one of the measurement resistors ZM, based on at least two of the output voltages resulting from the respective correction resistors ZC.

In the element array circuit 10, a voltage may be applied by the direct-current power supply PS2 to both the first parts PA of the unselected power feeding lines AU and positive input terminals T1 of the operational amplifiers OP to cause the first parts PA of the unselected power feeding lines AU and the positive input terminals T1 of the operational amplifiers OP to be at the second potential V2 having a value different from that of the first potential V1 of the first end of the one selected power feeding line AS selected from the power feeding lines A. In other words, the first parts PA of the unselected power feeding lines AU and the positive input terminals T1 of the operational amplifiers OP may be at the same potential, i.e., the second potential V2.

### [Readout Line B]

The readout lines B may correspond to a specific but non-limiting example of “second wirings” in one embodiment of the disclosure.

The readout lines B (B1 to Bn in FIG. 1) may each be a conductor extending from a node K (1, b) to an operational amplifier OPb. The readout lines B may include respective second parts PB (denoted as PB1 to PBn in FIG. 1) each extending in the second direction different from the first direction. The second parts PB1 to PBn may each be a part of corresponding one of the readout lines B1 to Bn. The second parts PB may be arranged to be adjacent to each other in the first direction different from the second direction. In the example embodiment illustrated in FIG. 1, “n” second parts PB may each extend in the Y-axis direction and may be arranged to be adjacent to each other in the X-axis direction. The second part PB1 may be a part from a node K (1, 1) to a node K (m, 1) in the readout line B1. The second part PB2 may be a part from a node K (1, 2) to a node K (m, 2) in the readout line B2. The second part PBn may be a part from a node K (1, n) to a node K (m, n) in the readout line Bn. Thus, the second part PBb may be a part from a node K (1, b) to a node K (m, b) in the readout line Bb. In other words, the second parts PB may each be a part, of corresponding one of the readout lines B, to which multiple ones of the resistors Z are coupled.

The readout line Bb may have a first end coupled to a second end of the resistor Z (1, b). The second end of the resistor Z (1, b) may be opposite to the first end, of the resistor Z (1, b), coupled to the power feeding line A1. In the example embodiment illustrated in FIG. 1, “m” resistors Z may be coupled to the readout line Bb. For example, the second end of the resistor Z (1, 1) may be coupled to the first end of the readout line B1 extending in the Y-axis direction. The readout line B1 and the resistor Z (1, 1) may be coupled to each other at the node K (1, 1). To the readout line B1, further, the resistor Z (2, 1) may be coupled at a node K (2, 1) and the resistor Z (m, 1) may be coupled at the node K (m, 1). Further, the second end of the resistor Z (1, 2) may be coupled to the first end of the readout line B2 extending in the Y-axis direction. The readout line B2 and the resistor Z (1, 2) may be coupled to each other at the node K (1, 2). To the readout line B2, further, the resistor Z (2, 2) may be coupled at a node K (2, 2) and the resistor Z (m, 2) may be coupled at the node K (m, 2). Further, the second end of the resistor Z (1, n) may be coupled to the first end of the readout line Bn extending in the Y-axis direction. The readout line Bn and the resistor Z (1, n) may be coupled to each other at the node K (1, n). To the readout line Bn, further, the resistor Z (2, n) may be coupled at a node K (2, n) and the resistor Z (m, n) may be coupled at the node K (m, n).

The readout lines B may each have a second end coupled to corresponding one of the operational amplifiers OP. The second end of each of the readout lines B may be opposite to the first end, of relevant one of the readout lines B, that is coupled to corresponding one of the resistors Z (1, b). For example, the second end of the readout line B1 may be coupled to a negative input terminal T2 of the operational amplifier OP1, the second end of the readout line B2 may be coupled to the negative input terminal T2 of the operational amplifier OP2, and the second end of the readout line Bn may be coupled to the negative input terminal T2 of the operational amplifier OPn. Through each of the readout lines B, signals flow that indicate respective states of the resistors Z coupled to relevant one of the readout lines B.

### [Resistor Z]

The resistors Z may correspond to a specific but non-limiting example of “impedance elements” in one embodiment of the disclosure.

The resistors Z may each be coupled to both one of the power feeding lines A and one of the readout lines B. The resistors Z may each have the first end coupled to the one of the power feeding lines A and the second end coupled to the one of the readout lines B. As described above, in the example embodiment illustrated in FIG. 1, “n” resistors Z may be coupled to each of the power feeding lines A, and “m” resistors Z may be coupled to each of the readout lines B. The number of the resistors Z coupled to both one of the power feeding lines A and one of the readout lines B may be one. Accordingly, it is possible to specify a single resistor Z by selecting a single power feeding line A from among the power feeding lines A and selecting a single readout line B from among the readout lines B.

Regarding the “n” resistors Z coupled to the power feeding line A1, in one example, the first end of the resistor Z (1, 1) may be coupled to the power feeding line A1 at the node P (1, 1), and the second end of the resistor Z (1, 1) may be coupled to the first end of the readout line B1 at the node K (1, 1). Further, the first end of the resistor Z (1, 2) may be coupled to the power feeding line A1 at the node P (1, 2), and the second end of the resistor Z (1, 2) may be coupled to the first end of the readout line B2 at the node K (1, 2). Further, the first end of the resistor Z (1, n) may be coupled to the power feeding line A1 at the node P (1, n), and the second end of the resistor Z (1, n) may be coupled to the first end of the readout line Bn at the node K (1, n). This similarly applies to the “n” resistors Z coupled to each of the power feeding lines A other than the power feeding line A1.

The resistors Z may each be a component of an infrared light receiving device that converts infrared rays condensed by, for example, a lens into an electric signal. In one example, the resistors Z may each include a resistance change layer whose resistance changes with changing temperature, for example. Non-limiting examples of the resistance change layer may include a thermistor film. The thermistor film may include, for example, vanadium oxide, amorphous silicon, polycrystalline silicon, a manganese-containing oxide having a spinel crystal structure, titanium oxide, or yttrium-barium-copper oxide. In the infrared light receiving device, an infrared absorption layer may be provided adjacent to the thermistor film. The infrared absorption layer may absorb infrared rays and generate heat. The infrared absorption layer may include, for example, silicon oxide (SiO₂), aluminum oxide (Al₂O₃), silicon nitride (Si₃N₄), or aluminum nitride (AlN). Temperatures of the infrared absorption layer and the resistance change layer may change with intensity of received infrared rays, and as a result, the resistance change layer of each of the resistors Z may change in electrical resistance value.

In performing measurement on the selected resistor ZS, one of the switches SWA1 that corresponds to the selected power feeding line AS, that is, the single power feeding line A to which the selected resistor ZS is coupled, may be set to the conducting state to cause a voltage to be applied from the direct-current power supply PS1 to the first end of the selected power feeding line AS. Further, in performing the measurement on the selected resistor ZS, a voltage may be applied from the second direct-current power supply PS2 to the first parts PA of the unselected power feeding lines AU, that is, all the power feeding lines A except the selected power feeding line AS, through the switches SWA2 that correspond to the respective unselected power feeding lines AU and that are in the conducting state.

By way of example, FIG. 1 illustrates a state where the resistors Z (1, 1) to Z (1, n) are selected to be the selected resistors ZS. In other words, FIG. 1 illustrates a state where the switch SWA1-1 is in the conducting state to cause a voltage to be applied from the direct-current power supply PS1 to the first end of the power feeding line A1 as the selected power feeding line AS corresponding to the selected resistors Z (1, 1) to Z (1, n), and where the first end of the power feeding line A1 is thus at the first potential V1. FIG. 1 further illustrates a state where the switches SWA2-2 to SWA2-m are in the conducting state to cause a voltage to be applied from the second direct-current power supply PS2 to the first parts PA of the power feeding lines A2 to Am as all the unselected power feeding lines AU other than the selected power feeding line A1, and where the first parts PA of the power feeding lines A2 to Am are at the second potential V2 different from the first potential V1. In this situation, the switches SWA1-2 to SWA1-m provided on the power feeding lines A2 to Am as the unselected power feeding lines AU may all be in the nonconducting state, and the switch SWA2-1 corresponding to the power feeding line A1 as the selected power feeding line AS may also be in the nonconducting state. Note that the first potential V1 and the second potential V2 may be simply different from each other. Either the first potential V1 or the second potential V2 may be 0 V.

### [Operational Amplifier OP]

The operational amplifiers OP may each be coupled to corresponding one of the readout lines B. The operational amplifiers OP, which are denoted as OP1 to OPn in FIG. 1, may each include the positive input terminal T1, the negative input terminal T2, and the output terminal T3. The positive input terminal T1 of each of the operational amplifiers OP may be coupled to, for example, the direct-current power supply PS2, and may thus be set to the second potential V2 different from the first potential V1. The second potential V2 may be 0 V, for example. The negative input terminal T2 of each of the operational amplifiers OP may be coupled to the corresponding one of the readout lines B. Each of the operational amplifiers OP may operate to cause the positive input terminal T1 and the negative input terminal T2 to be at the same potential, and accordingly, the potential at the negative input terminal T2 may become substantially equal to the second potential V2. In each of the operational amplifiers OP, the output terminal T3 may be coupled to one corresponding negative input terminal T2 through one corresponding resistor RE. [Resistor RE]

The resistors RE may each include a resistor element including, for example, a metal material having a predetermined specific resistance. The resistors RE may each be coupled to both the negative input terminal T2 and the output terminal T3 of corresponding one of the operational amplifiers OP, and may each convert a current flowing through the readout line B coupled to the negative input terminal T2 into a voltage. In one example, in the example embodiment illustrated in FIG. 1, the resistor RE1 may be coupled to both the negative input terminal T2 and the output terminal T3 of the operational amplifier OP1, and may convert a current flowing through the readout line B1 into a voltage. Similarly, the resistor RE2 may be coupled to both the negative input terminal T2 and the output terminal T3 of the operational amplifier OP2, and may convert a current flowing through the readout line B2 into a voltage; and the resistor REn may be coupled to both the negative input terminal T2 and the output terminal T3 of the operational amplifier OPn, and may convert a current flowing through the readout line Bn into a voltage.

### [Measurement Operation of Sensor Apparatus 1]

The sensor apparatus 1 may measure output voltages corresponding to the respective resistors Z in the following manner, for example, in a measurement environment in which electromagnetic waves, such as infrared rays, are applied to the sensor apparatus 1. The following measurement operation may be performed in accordance with a command from the control circuit 20.

First, the power feeding line A corresponding to the selected resistor ZS targeted for measurement may be selected to be the selected power feeding line AS. For example, the switch SWA1 of the selected power feeding line AS to which the selected resistor ZS is coupled may be set to the conducting state and a voltage may be applied from the direct-current power supply PS1 to the first end of the selected power feeding line AS to cause the first end of the selected power feeding line AS to be at the first potential V1. The other switches SWA1 corresponding to the unselected power feeding lines AU may be set to the nonconducting state. Further, the switches SWA2 corresponding to the unselected power feeding lines AU may be set to the conducting state and a voltage may be applied from the direct-current power supply PS2 to the first parts PA of the unselected power feeding lines AU to cause the first parts PA of the unselected power feeding lines AU to be at the second potential V2. The switch SWA2 corresponding to the selected power feeding line AS may be set to the nonconducting state. FIG. 1 illustrates an example state where the resistors Z (1, 1) to Z (1, n) are selected to be the selected resistors ZS. In this case, the switch SWA1-1 corresponding to the power feeding line A1 as the selected power feeding line AS may be set to the conducting state and a voltage may be applied from the direct-current power supply PS1 to the first end of the power feeding line A1. The switches SWA1-2 to SWA1-m corresponding to the power feeding lines A2 to Am as the unselected power feeding lines AU may be set to the nonconducting state. Further, the switches SWA2-2 to SWA2-m corresponding to the power feeding lines A2 to Am as the unselected power feeding lines AU may be set to the conducting state and a voltage may be applied from the direct-current power supply PS2 to the first parts PA2 to PAm of the power feeding lines A2 to Am. The switch SWA2-1 corresponding to the power feeding line A1 as the selected power feeding line AS may be set to the nonconducting state. The positive input terminal T1 of each of the operational amplifiers OP1 to OPn may also be at the second potential V2. As a result, the voltage to be applied to the resistors Z other than the resistors Z (1, 1) to Z (1, n) as the selected resistors ZS is zero, which allows no current to flow through the resistors Z other than the resistors Z (1, 1) to Z (1, n).

Thereafter, an output voltage corresponding to each selected resistor ZS may be measured. For example, the output voltage may be measured that results from each selected resistor ZS coupled to both the selected power feeding line AS and one corresponding readout line B and that is outputted from the output terminal T3 of one operational amplifier OP corresponding to the one readout line B. In the example embodiment of FIG. 1, when the resistor Z (1, 1) coupled to both the power feeding line A1 and the readout line B1 is one selected resistor ZS, an output voltage Vout outputted from the output terminal T3 of the operational amplifier OP1 corresponding to the resistor Z (1, 1) may be measured. When the resistor Z (1, 2) coupled to both the power feeding line A1 and the readout line B2 is one selected resistor ZS, an output voltage Vout outputted from the output terminal T3 of the operational amplifier OP2 corresponding to the resistor Z (1, 2) may be measured. When the resistor Z (1, n) coupled to both the power feeding line A1 and the readout line Bn is one selected resistor ZS, an output voltage Vout outputted from the output terminal T3 of the operational amplifier OPn corresponding to the resistor Z (1, n) may be measured. Respective potentials Vf (Vfl to Vfn) at the nodes P (P (1, 1) to P (1, n)) on the power feeding line A1 may each be different from a potential at the node K (one of the nodes K (1, 1) to K (1, n)) corresponding to relevant one of the nodes P, that is, a potential at the readout line B (one of the readout lines B1 to Bn) corresponding to the relevant one of the nodes P. In other words, the potential at each of the nodes P on the selected power feeding line AS, that is, the potential at each of the nodes P to which corresponding one of the selected resistors ZS is coupled, may be different from the potential at the node K corresponding to relevant one of the nodes P, that is, the potential at the readout line B corresponding to the relevant one of the nodes P. The potential at the node K, i.e., the potential at the readout line B, may be almost equal to the second potential V2 that is the potential at the negative input terminal T2. To each of the resistors Z (1, 1) to Z (1, n), a voltage may be applied that corresponds to a difference between one of the potentials Vfl to Vfn at corresponding one of the nodes P (1, 1) to P (1, n) and the potential at corresponding one of the readout lines B1 to Bn. As a result, currents corresponding to respective resistance values of the resistors Z (1, 1) to Z (1, n) may flow through the respective resistors Z (1, 1) to Z (1, n). The current flowing through each of the resistors Z (1, 1) to Z (1, n) may flow through corresponding one of the readout lines B1 to Bn. The current flowing through each of the readout lines B1 to Bn may be converted into a voltage by corresponding one of the resistors RE1 to REn, and outputted as the output voltage Vout from the output terminal T3 of one of the operational amplifiers OP1 to OPn corresponding to relevant one of the resistors Z (1, 1) to Z (1, n). The output voltage Vout may be expressed by Expression (1) below.

$$Vout = - ( Re / Rz ) \times ( V 1 - V 2 ) + V 2 \qquad ( 1 )$$

where:
Re is a resistance value of one resistor RE coupled to the operational amplifier OP corresponding to relevant one of the selected resistors ZS;
Rz is a resistance value of the relevant one of the selected resistors ZS; Vf is the potential at the node P corresponding to the relevant one of the selected resistors ZS; and
V2 is the second potential that is the potential at the positive input terminal T1.

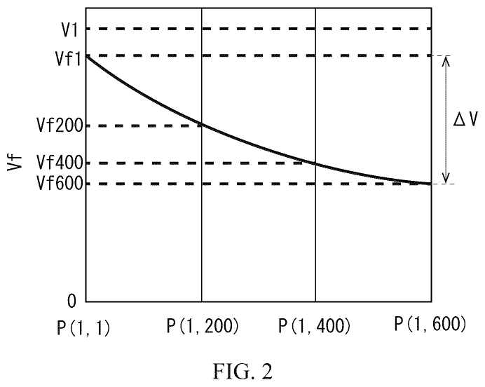

Here, the potential Vf should ideally be equal to the first potential VI that is the potential at the first end of the power feeding line A. In actuality, however, because a drop in voltage may occur due to the wiring resistance of the power feeding line A itself, the potential Vf may become lower than the first potential V1 (Vf<V1). FIG. 2 is a characteristic diagram schematically illustrating a relationship between a position of each of the nodes P (1, 1) to P (1, n) on the power feeding line A1 and the potential Vf at the position of corresponding one of the nodes P (1, 1) to P (1, n) in the element array circuit 10 where n=600. In FIG. 2, the horizontal axis represents the respective positions of the nodes P (1, 1) to P (1, n) on the power feeding line A1, and the vertical axis represents the potential Vf. As indicated in FIG. 2, as a distance from the node P (1, 1) that is the first end of the first part PA increases, the potential Vf at the node P may decrease to become more different from the first potential V1. For example, a potential Vf200 at a node P (1, 200) to which a 200th resistor Z (1, 200) from the first end of the first part PA is coupled may be lower than the potential Vfl at the node P (1, 1). Furthermore, a potential Vf400 at a node P (1, 400) to which a 400th resistor Z (1, 400) from the first end of the first part PA is coupled may be lower than the potential Vf200. Furthermore, a potential Vf600 at a node P (1, 600) to which a 600th resistor Z (1, 600) from the first end of the first part PA is coupled may be lower than the potential Vf400. The potential Vf600 may exhibit a drop with respect to the potential Vfl by ΔV. Here, if a current flowing through a “b”-th section among multiple sections of a path from the node P (1, 1) to the node P (1, 600) is denoted as I (1, b) and an electrical resistance value of the “b”-th section is denoted as R (1, b), a drop voltage ΔV occurring across a part from the node P (1, 1) to the node P (1, n) may be given by: ΔV=Σ{I (1, b)× R (1, b)}, where b is an integer within a range from 1 to n-1 both inclusive.

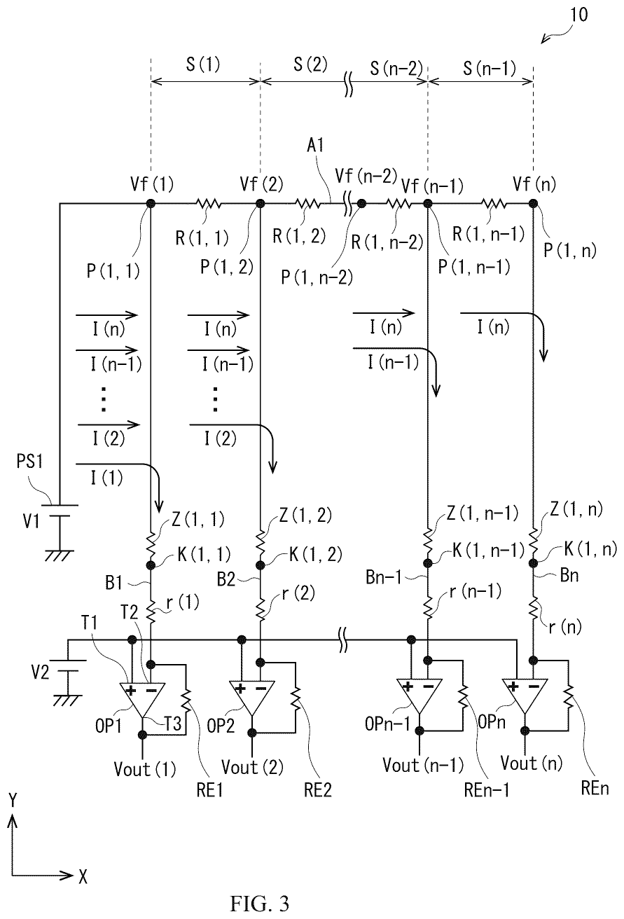

The drop voltage ΔV may increase with increasing number of the resistors Z coupled in parallel. FIG. 3 is an explanatory diagram illustrating a relationship between an increase in the number of the resistors Z coupled in parallel and an increase in the drop voltage ΔV in the element array circuit 10. Here, if the potential at the node P (1, n) is denoted as Vf (n), a drop voltage ΔV (n-1) occurring across a section S (n-1) may be given by Vf (n-1)-Vf (n), a drop voltage ΔV (n-2) occurring across a section S (n-2) may be given by Vf (n-2)-Vf (n-1), and a drop voltage ΔV (1) occurring across a section S (1) may be given by Vf (1)-Vf (2). Note that the section S (n-1) is a part, of the power feeding line A1, between the node P (1, n) and a node P (1, n-1) before the node P (1, n). The node P (1, n-1) is a node between the power feeding line A1 and the resistor Z (1, n-1). Similarly, the section S (n-2) is a part, of the power feeding line A1, between the node P (1, n-1) and a node P (1, n-2) before the node P (1, n-1). The section S (1) is a part, of the power feeding line A1, between the node P (1, 2) and the node P (1, 1) before the node P (1, 2).

Accordingly, if a drop voltage occurring across a part from the direct-current power supply PS1 to the node P (1, 1) is denoted as ΔV (0), the potential Vf (1) at the node P (1, 1) may be lower in value than VI by ΔV (0). That is, the following expression may hold:

$$Vf ( 1 ) = V 1 - Δ V ( 0 ) .$$

Similarly, the potential Vf (2) at the node P (1, 2) may be given by:

$$Vf ( 2 ) = V 1 - \{ Δ V ( 0 ) + Δ V ( 1 ) \} ,$$

the potential Vf (n-1) at the node P (1, n-1) may be given by:

$$Vf ( n - 1 ) = V 1 - \{ Δ V ( 0 ) + Δ V ( 1 ) + … + Δ V ( n - 2 ) \} ,$$

the potential Vf (n) at the node P (1, n) may be given by:

$$Vf ( n ) = V 1 - \{ Δ V ( 0 ) + Δ V ( 1 ) + … + Δ V ( n - 2 ) + Δ V ( n - 1 ) \} .$$

Accordingly, the drop voltage ΔV, with respect to V1, of the potential Vf (n) at the node P (1, n) located farthest from the first end of the first part PA among the nodes P (1, 1) to P (1, n) may increase with increasing number n of the resistors Z coupled in parallel.

Further, as illustrated in FIG. 3, only a current I (n) passing through the node P (1, n) may flow through the resistor Z (1, n) farthest from the node P (1, 1), i.e., the first end of the first part PA. In other words, only the current I (n) may flow through the section S (n-1) of the first part PA. The current I (n) may be a current flowing through the resistor Z (1, n). Further, a current I (n-1) in addition to the current I (n) may flow through the section S (n-2) of the first part PA. The current I (n-1) may be a current flowing through the resistor Z (1, n-1). Further, currents I (2) to I (n) respectively flowing through the resistors Z (1, 2) to Z (1, n) may all flow through the section S (1). Furthermore, currents I (1) to I (n) respectively flowing through the resistors Z (1, 1) to Z (1, n) may all flow through the part from the direct-current power supply PS1 to the node P (1, 1). The drop voltage across a section S sandwiched by two adjacent nodes P may increase proportionately with a product of the electrical resistance value of the section S and the current flowing through the section S. A total amount of the current I to flow through may be larger in a section closer to the node P (1, 1), i.e., the first end of the first part PA. Accordingly, the section closer to the node P (1, 1) may be more likely to exhibit a large drop voltage. In this way, the drop in voltage caused by the current flowing through the power feeding line A and the resistance of the power feeding line A may be likely to be large.

Due to the occurrence of such a drop voltage, the potential Vf may have different values depending on respective coupling positions of the resistors Z to the power feeding line A. This degrades accuracy of a measured value of the output voltage Vout for a physical quantity targeted for measurement. For example, even when infrared rays of the same intensity are applied to the resistors Z, values of the output voltages Vout may be different depending on the respective coupling positions of the resistors Z to the power feeding line A, resulting in a difference between detected intensities of the infrared rays. In other words, a measurement error may occur. It is thus necessary to take some countermeasures, such as correction of the measured value in accordance with the drop voltage. However, the drop voltage may vary under the influence of the currents I flowing through the respective resistors Z. In other words, the drop voltage may change with the respective electrical resistance values of the resistors Z. For example, a change in environmental temperature may change the resistance value of each resistor Z, which may in turn change the drop voltage. It is thus not easy to correct the above-described measurement error.

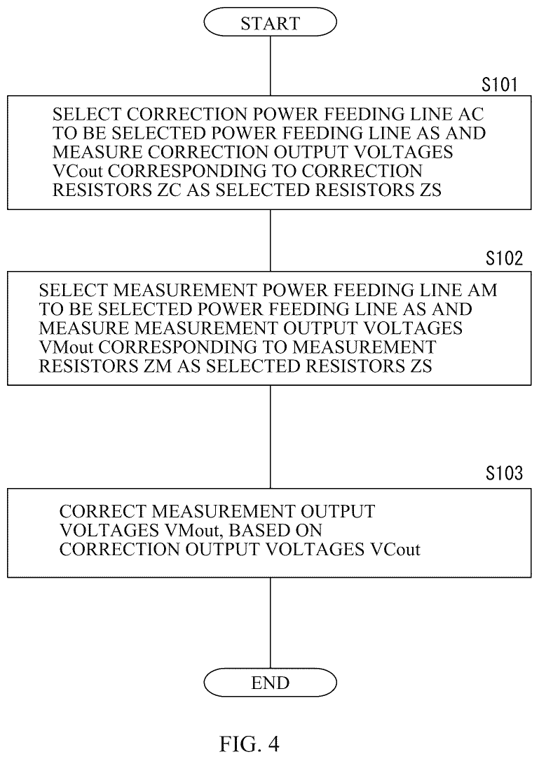

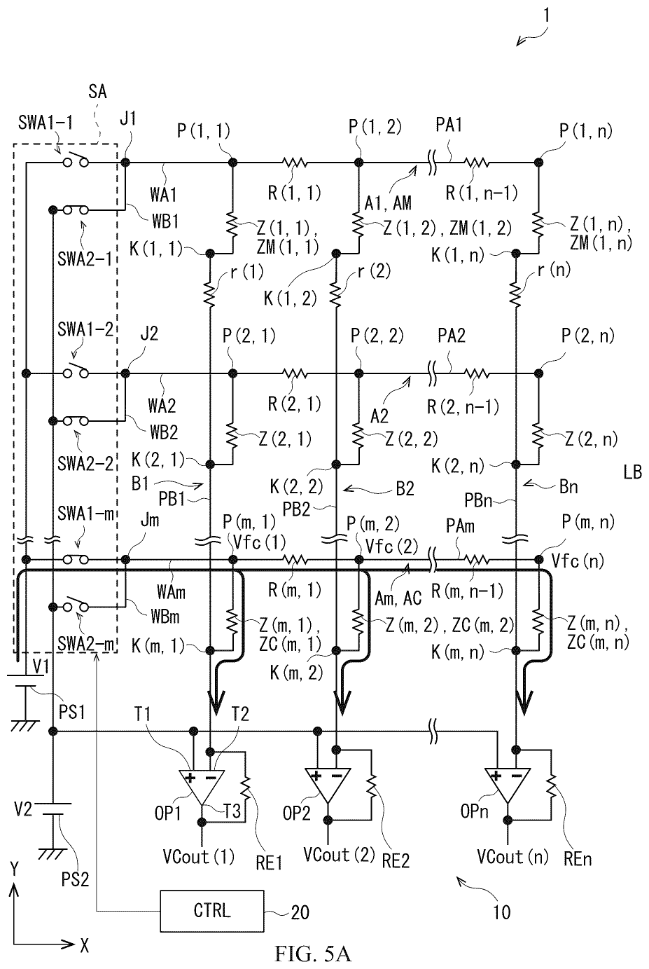

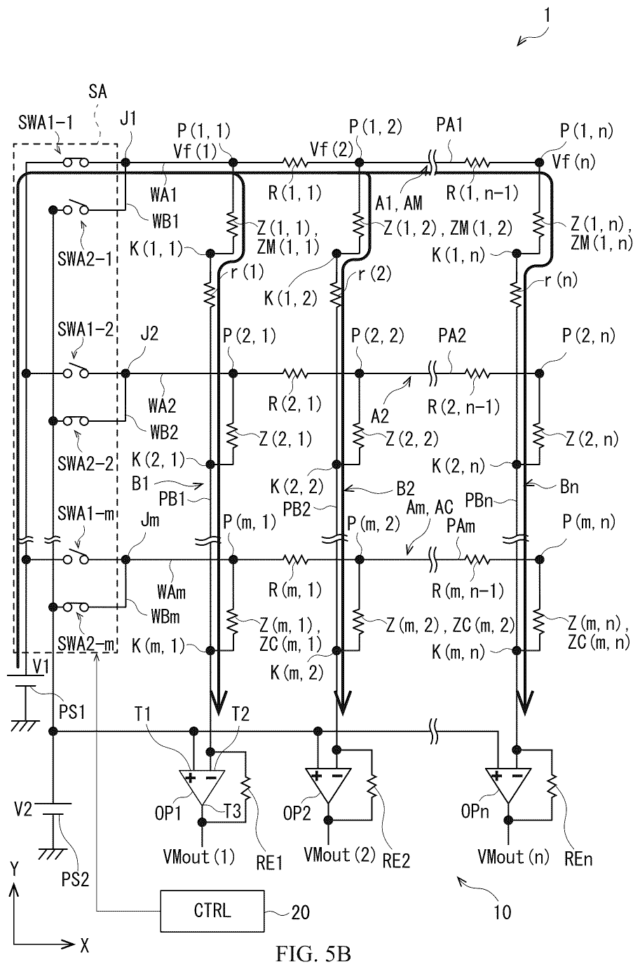

To address this, in the sensor apparatus 1 of the example embodiment, the control circuit 20 corrects an output voltage resulting from at least one of the measurement resistors ZM coupled to the one measurement power feeding line AM, based on least two of output voltages resulting from the respective correction resistors ZC coupled to the one correction power feeding line AC. Note that, for ease of understanding, a description is given herein on the assumption that a drop in voltage caused by a current flowing through the readout line B and the resistance of the readout line B is negligible. Correction processing to be performed by the control circuit 20 will be described with reference to a flowchart in FIG. 4 and explanatory diagrams in FIGS. 5A and 5B, in addition to the circuit diagram in FIG. 1. The flowchart in FIG. 4 describes an example of the measurement operation to be performed by the sensor apparatus 1 illustrated in FIG. 1. FIG. 5A is a first explanatory diagram describing the example of the measurement operation to be performed by the sensor apparatus 1 illustrated in FIG. 1. FIG. 5B is a second explanatory diagram describing the example of the measurement operation to be performed by the sensor apparatus 1 illustrated in FIG. 1. In the following description, the power feeding line A1 is assumed to be the measurement power feeding line AM, and the power feeling line Am is assumed to be the correction power feeding line AC. Thus, the resistors Z (1, 1) to Z (1, n) are the measurement resistors ZM (1, 1) to ZM (1, n), and the resistors Z (m, 1) to Z (m, n) are the correction resistors ZC (m, 1) to ZC (m, n).

First, the control circuit 20 may select the correction power feeding line AC to be the selected power feeding line AS, and measure respective correction output voltages VCout of the correction resistors ZC as the selected resistors ZS (step S101). For example, as illustrated in FIG. 5A, the switch SWA1-m corresponding to the power feeding line Am as the correction power feeding line AC may be set to the conducting state and the switch SWA2-m may be set to the nonconducting state. In other words, at the power feeding line selector SA, only the switch SWA1-m of the switches SWA1 (SWA1-1 to SWA1-m) may be set to the conducting state, and the switches SWA1-1 to SWA1-(m-1) other than the switch SWA1-m may be set to the nonconducting state. Further, at the power feeding line selector SA, only the switch SWA2-m of the switches SWA2 (SWA2-1 to SWA2-m) may be set to the nonconducting state, and the switches SWA2-1 to SWA2-(m-1) other than the switch SWA2-m may be set to the conducting state. By such an operation, the potential at node P (m, 1) may be set to Vfc (1), the potential at the node P (m, 2) may be set to Vfc (2), and the potential at the node P (m, n) may be set to Vfc (n). This allows for measurement of correction output voltages VCout (1) to VCout (n) from the output terminals T3 of the operational amplifiers OP1 to OPn that respectively correspond to the correction resistors ZC (m, 1) to ZC (m, n).

Thereafter, the control circuit 20 may select the measurement power feeding line AM to be the selected power feeding line AS, and measure respective measurement output voltages VMout corresponding to the measurement resistors ZM as the selected resistors ZS (step S102). For example, as illustrated in FIG. 5B, the switch SWA1-1 corresponding to the power feeding line A1 as the measurement power feeding line AM may be set to the conducting state and the switch SWA2-1 may be set to the nonconducting state. In other words, at the power feeding line selector SA, only the switch SWA1-1 of the switches SWA1 (SWA1-1 to SWA1-m) may be set to the conducting state, and the switches SWA1-2 to SWA1-m other than the switch SWA1-1 may be set to the nonconducting state. Further, at the power feeding line selector SA, only the switch SWA2-1 of the switches SWA2 (SWA2-1 to SWA2-m) may be set to the nonconducting state, and the switches SWA2-2 to SWA2-m other than the switch SWA2-1 may be set to the conducting state. By such an operation, the potential at node P (1, 1) may be set to Vf (1), the potential at the node P (1, 2) may be set to Vf (2), and the potential at the node P (1, n) may be set to Vf (n). This allows for measurement of measurement output voltages VMout (1) to VMout (n) from the output terminals T3 of the operational amplifiers OP1 to OPn that respectively correspond to the measurement resistors ZM (1, 1) to ZM (1, n). Note that as description above, the measurement output voltages VMout (1) to VMout (n) corresponding to all the measurement resistors ZM (1, 1) to ZM (1, n) may be measured; however, in some embodiments, only some of the measurement output voltages VMout (1) to VMout (n) may be measured.

Thereafter, the control circuit 20 may correct measured values of the measurement output voltages VMout, based on measured values of the correction output voltages VCout (step S103). For example, the measurement output voltages VMout (1) to VMout (n) that respectively correspond to the resistors ZM (1, 1) to ZM (1, n) coupled to the measurement power feeding line AM (the power feeding line A1 in FIGS. 5A and 5B) may be corrected as given by Expressions (2.1) to (2.n) below. Note that as indicated by Expression (2.1), the measurement output voltage VMout (1) corresponding to the resistor ZM (1, 1) may be at the same value before and after the correction.

$$\begin{matrix}( VMout ( 1 ) - V 2 ) \times \frac{VCout ( 1 ) - V 2}{VCout ( 1 ) - V 2} & ( 2.1 ) \\ ( VMout ( 2 ) - V 2 ) \times \frac{VCout ( 1 ) \to V 2}{VCout ( 2 ) - V 2} \\ ⋮ & ( 2.2 ) \\ ( VMout ( n ) - V 2 ) \times \frac{VCout ( 1 ) - V 2}{VCout ( n ) - V 2} & ( 2. n )\end{matrix}$$

For example, a measurement output voltage VMout (b) corresponding to a resistor ZM (1, b), among the resistors ZM (1, 1) to ZM (1, n), that is coupled at the “b”-th node from the node P (1, 1) may be corrected as given by Expression (2.b) below. Note that in Expression (2,b), b is an integer within a range from 1 to n both inclusive.

$$( VMout ( b ) - V 2 ) \times \frac{VCout ( 1 ) - V 2}{VCout ( b ) - V 2} \qquad ( 2. b )$$

Accordingly, respective resistance values Rz (1, 1) to Rz (1, n) of the resistors ZM (1, 1) to ZM (1, n) may be determined by Equations (3.1) to (3.n) below. In actuality, the measurement output voltages VMout (1) to VMout (n) may be corrected without determining the resistance values Rz (1, 1) to RZ (1, n); however, a procedure of determining the resistance values Rz (1, 1) to RZ (1, n) is described to aid in understanding. Note that in Equations (3.1) to (3.n), Re (1) to Re (n) represent respective resistance values of the resistors RE1 to REn coupled to the operational amplifiers OP1 to OPn corresponding to the respective measurement resistors ZM (1, 1) to ZM (1, n); VMout (1) to VMout (n) represent the measurement output voltages from the output terminals T3 of the operational amplifiers OP1 to OPn corresponding to the respective measurement resistors ZM (1, 1) to ZM (1, n); and VCout (1) to VCout (n) represent the correction output voltages from the output terminals T3 of the operational amplifiers OP1 to OPn corresponding to the respective correction resistors ZC (m, 1) to ZC (m, n)

$$\begin{matrix}R z ( 1 , 1 ) = \frac{- Re ( 1 )}{VMout ( 1 ) - V 2} \times \{ \frac{VCout ( 1 ) - V 2}{VCout ( 1 ) - V 2} \times ( V 1 - V 2 ) \} & ( 3.1 ) \\ R z ( 1 , 2 ) = \frac{- Re ( 2 )}{VMout ( 2 ) - V 2} \times \{ \frac{VCout ( 2 ) - V 2}{VCout ( 1 ) - V 2} \times ( V 1 - V 2 ) \} \\ ⋮ & ( 3.2 ) \\ R z ( 1 , n ) = \frac{- Re ( n )}{VMout ( n ) - V 2} \times \{ \frac{VCout ( n ) - V 2}{VCout ( 1 ) - V 2} \times ( V 1 - V 2 ) \} & ( 3. n )\end{matrix}$$

For example, the resistance value Rz (1, b) of the resistor ZM (1, b), among the resistors ZM (1, 1) to ZM (1, n), that is coupled at the “b”-th node from the node P (1, 1) may be determined by Equation (3.b) below. In Equation (3.b), Re (b) represents the resistance value of the resistor REb coupled to the operational amplifier OPb corresponding to the resistor ZM (1, b). Note that any power feeding line A other than the power feeding line A1 may be designated as the measurement power feeding line AM, and corrected resistance values Rz of the measurement resistors ZM may be determined by the above-described procedure, similarly to a case of the power feeding line A1.

$$R z ( 1 , b ) = \frac{- Re ( b )}{VMout ( b ) - V 2} \times \{ \frac{VCout ( b ) - V 2}{VCout ( 1 ) - V 2} \times ( V 1 - V 2 ) \} \qquad ( 3. b )$$

Equations (3.1) to (3.n) above may be derived as follows.

First, theoretical equations of the correction output voltages VCout (1) to VCout (n) in the state illustrated in FIG. 5A may be as given by Equations (4.1) to (4.n) below. In Equations (4.1) to (4.n), Vfc (1) to Vfc (n) respectively represent the potentials at the nodes P (m, 1) to P (m, n); Re (1) to Re (n) respectively represent the resistance values of the resistors RE1 to REn coupled to the operational amplifiers OP1 to OPn; and Rc (1) to Rc (n) respectively represent the resistance values of the correction resistors ZC (m, 1) to ZC (m, n).

$$\begin{matrix}VCout ( 1 ) = V 2 - Re ( 1 ) \times \frac{Vfc ( 1 ) - V 2}{Rc ( 1 )} & ( 4.1 ) \\ VCout ( 2 ) = V 2 - Re ( 2 ) \times \frac{Vfc ( 2 ) - V 2}{Rc ( 2 )} \\ ⋮ & ( 4.2 ) \\ VCout ( n ) = V 2 - Re ( n ) \times \frac{Vfc ( n ) - V 2}{Rc ( n )} & ( 4. n )\end{matrix}$$

By dividing Equations (4.2) to (4.n) by Equation (4.1), Equations (5.1) to (5.n) below may be obtained.

$$\begin{matrix}\frac{VCout ( 2 ) - V 2}{VCout ( 1 ) - V 2} = \frac{Vfc ( 2 ) - V 2}{Vfc ( 1 ) - V 2} & ( 5.1 ) \\ \frac{VCout ( 3 ) - V 2}{VCout ( 1 ) - V 2} = \frac{Vfc ( 3 ) - V 2}{Vfc ( 1 ) - V 2} \\ ⋮ & ( 5.2 ) \\ \frac{VCout ( n ) - V 2}{VCout ( 1 ) - V 2} = \frac{Vfc ( n ) - V 2}{Vfc ( 1 ) - V 2} & ( 5. n )\end{matrix}$$

Further, Equations (5.1) to (5.n) may be transformed into Equations (6.1) to (6.n) below.

$$\begin{matrix}Vfc ( 1 ) = \{ \frac{VCout ( 1 ) - V 2}{VCout ( 1 ) - V 2} \times ( Vfc ( 1 ) - V 2 ) \} + V 2 & ( 6.1 ) \\ Vfc ( 2 ) = \{ \frac{VCout ( 2 ) - V 2}{VCout ( 1 ) - V 2} \times ( Vfc ( 1 ) - V 2 ) \} + V 2 \\ ⋮ & ( 6.2 ) \\ Vfc ( n ) = \{ \frac{VCout ( n ) - V 2}{VCout ( 1 ) - V 2} \times ( Vfc ( 1 ) - V 2 ) \} + V 2 & ( 6. n )\end{matrix}$$

Provided that a part of the element array circuit 10 from the direct-current power supply PS1 to the node P (m, 1) is sufficiently low in resistance value, Vfc (1) may be replaced with V1. In other words, Equations (7.1) to (7.n) below may be obtained by replacing Vfc (1) in Equations (6.1) to (6.n) with V1.

$$\begin{matrix}Vfc ( 1 ) = V 1 & ( 7.1 ) \\ Vfc ( 2 ) = \frac{VCout ( 2 ) - V 2}{VCout ( 1 ) - V 2} \times ( V 1 - V 2 ) + V 2 \\ ⋮ & ( 7.2 ) \\ Vfc ( n ) = \frac{VCout ( n ) - V 2}{VCout ( 1 ) - V 2} \times ( V 1 - V 2 ) + V 2 & ( 7. n )\end{matrix}$$

Next, theoretical equations of the measurement output voltages VMout (1) to VMout (n) in the state illustrated in FIG. 5B may be as given by Equations (8.1) to (8.n) below. In Equations (8.1) to (8.n), Vf (1) to Vf (n) respectively represent the potentials at the nodes P (1, 1) to P (1, n); Re (1) to Re (n) respectively represent the resistance values of the resistors RE1 to REn coupled to the operational amplifiers OP1 to OPn; and Rz (1, 1) to Rz (1, n) respectively represent the resistance values of the measurement resistors ZM (1, 1) to ZM (1, n).

$$\begin{matrix}VMout ( 1 ) = - Re ( 1 ) \times \frac{Vf ( 1 ) - V 2}{Rz ( 1 , 1 )} + V 2 & ( 8.1 ) \\ VMout ( 2 ) = - Re ( 2 ) \times \frac{Vf ( 2 ) - V 2}{Rz ( 1 , 2 )} + V 2 \\ ⋮ & ( 8.2 ) \\ VMout ( n ) = - Re ( n ) \times \frac{Vf ( n ) - V 2}{Rz ( 1 , n )} + V 2 & ( 8. n )\end{matrix}$$

Equations (8.1) to (8.n) may be transformed into Equations (9.1) to (9.n) to determine the resistance values Rz (1, 1) to Rz (1, n).

$$\begin{matrix}R z ( 1 , 1 ) = \frac{- Re ( 1 )}{VMout ( 1 ) - V 2} \times ( Vf ( 1 ) - V 2 ) & ( 9.1 ) \\ R z ( 1 , 2 ) = \frac{- Re ( 2 )}{VMout ( 2 ) - V 2} \times ( Vf ( 2 ) - V 2 ) \\ ⋮ & ( 9.2 ) \\ R z ( 1 , n ) = \frac{- Re ( n )}{VMout ( n ) - V 2} \times ( Vf ( n ) - V 2 ) & ( 9. n )\end{matrix}$$

Provided that a difference between the electrical resistance value of a section S of the correction power feeding line AC at the time of measurement and the electrical resistance value of a corresponding section S of the measurement power feeding line AM at the time of measurement is sufficiently small and a difference between the electrical resistance value of the correction resistor ZC at the time of measurement and the electrical resistance value of the measurement resistor ZM at the time of measurement is sufficiently small (or substantially zero), Vf (1) to Vf (n) may be replaced with Vfc (1) to Vfc (n), respectively. In other words, Equations (10.1) to (10.n) below may be obtained from Equations (9.1) to (9.n).

$$\begin{matrix}R z ( 1 , 1 ) = \frac{- Re ( 1 )}{VMout ( 1 ) - V 2} \times ( Vfc ( 1 ) - V 2 ) & ( 10.1 ) \\ R z ( 1 , 2 ) = \frac{- Re ( 2 )}{VMout ( 2 ) - V 2} \times ( Vfc ( 2 ) - V 2 ) \\ ⋮ & ( 10.2 ) \\ R z ( 1 , n ) = \frac{- Re ( n )}{VMout ( n ) - V 2} \times ( Vfc ( n ) - V 2 ) & ( 10. n )\end{matrix}$$

Further, by substituting the respective right sides of Equations (7.1) to (7.n) into Vfc (1) to Vfc (n) in Equations (10.1) to (10.n), the foregoing Equations (3.1) to (3.n) may be obtained. The control circuit 20 may thus correct, for example, the measurement output voltage VMout (b) corresponding to the resistor ZM (1, b), among the resistors ZM (1, 1) to ZM (1, n), that is coupled at the “b”-th node from the node P (1, 1), in a manner given by Expression (2.b). Given the same environmental temperature, a drop in voltage occurring across a part from the first end of the correction power feeding line AC to the correction resistor ZC (m, b) and a drop in voltage occurring across a part from the first end of the measurement power feeding line AM to the resistor ZM (1, b) are assumable to be similar. Accordingly, as given by Expression (2.b), the output voltage VCout (1) resulting from a “q”-th correction resistor ZC (m, 1) from the first end of the correction power feeding line AC (where “q” is a natural number and in this case, equal to 1), the “q”-th correction resistor ZC (m, 1) being coupled to a node at which a drop in voltage from the potential V1 is relatively small, and an output voltage VCout (r) resulting from an “r”-th correction resistor ZC (m, r) from the first end of the correction power feeding line AC (where “r” is a natural number greater than “q”), the “r”-th correction resistor ZC (m, r) being coupled to a node at which a drop in voltage from the potential VI is relatively large, may be used to correct an output voltage VMout (r) resulting from a resistor ZM (1, r). This helps to mitigate an influence of the drop in voltage on measurement accuracy for s physical quantity targeted for measurement that is to be measured with the resistor ZM (1, r) coupled to a node at which a drop in voltage from the potential VI is relatively large. Note that the description here is given of a case where q=1; however, q may be a natural number of two or more. Further, correction may be omitted for an output voltage that results from a resistor ZM (1, q) coupled to a note at which a drop in voltage is relatively small, that is, where q is a small value.

### [Workings and Example Effects of Sensor Apparatus 1]

As described above, in the sensor apparatus 1 of the example embodiment, the control circuit 20 corrects the measurement output voltage VMout resulting from at least one of the measurement resistors ZM that are coupled to one measurement power feeding line AM other than the correction power feeding line AC, based on at least two of the correction output voltages VCout (for example, the correction output voltage VCout (1) and a correction output voltage VCout (b)) that each result from corresponding one of the correction resistors ZC coupled to the correction power feeding line AC. This helps to mitigate the influence of the wiring resistance of the measurement power feeding line AM on the measurement accuracy for a physical quantity targeted for measurement.

Accordingly, the sensor apparatus 1 of the example embodiment helps to achieve high measurement accuracy for a physical quantity targeted for measurement, such as an intensity of infrared rays or other electromagnetic waves applied to the element array circuit 10.

### 2. Second Example Embodiment

### Overall Configuration Example of Sensor Apparatus 2

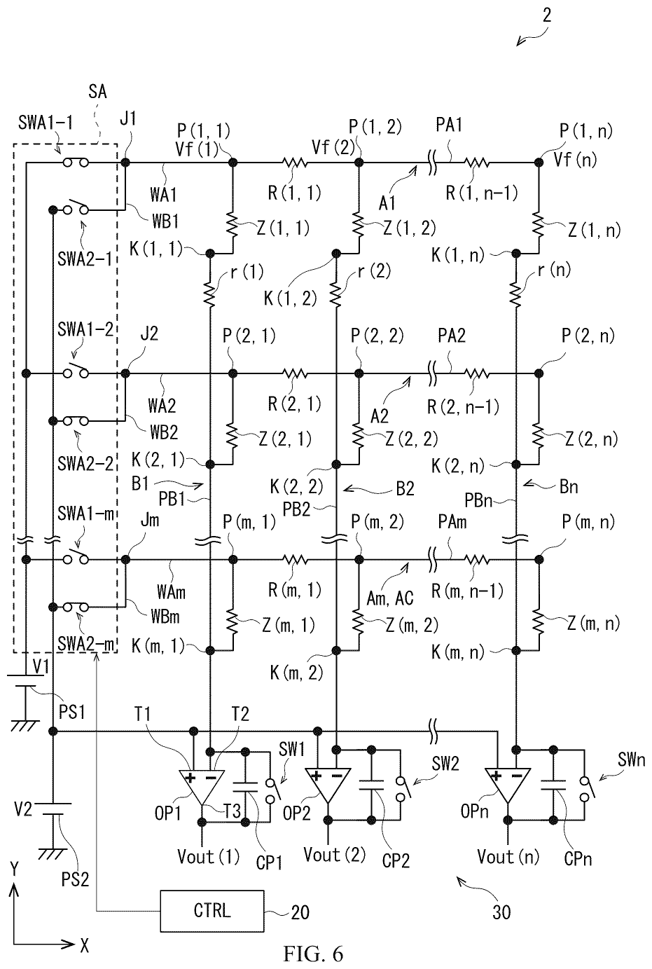

FIG. 6 is a circuit diagram schematically illustrating a configuration example of a sensor apparatus 2 according to a second example embodiment of the disclosure. The sensor apparatus 2 includes an element array circuit 30 and the control circuit 20, for example. As illustrated in FIG. 6, the element array circuit 30 may have a configuration different from the configuration of the element array circuit 10 of FIG. 1 in that multiple capacitors CP (CP1 to CPn) and multiple switches SW (SW1 to SWn) are provided, instead of the resistors RE (RE1 to REn), in correspondence with the multiple operational amplifiers OP (OP1 to OPn).

The capacitors CP may each be coupled to both the negative input terminal T2 and the output terminal T3 of corresponding one of the operational amplifiers OP, and may each convert a current flowing through the readout line B coupled to the negative input terminal T2 into a voltage. For example, in the example embodiment illustrated in FIG. 6, the capacitor CP1 may be coupled to both the negative input terminal T2 and the output terminal T3 of the operational amplifier OP1 and may convert a current flowing through the readout line B1 into a voltage. Similarly, the capacitor CP2 may be coupled to both the negative input terminal T2 and the output terminal T3 of the operational amplifier OP2 and may convert a current flowing through the readout line B2 into a voltage; and the capacitor CPn may be coupled to both the negative input terminal T2 and the output terminal T3 of the operational amplifier OPn and may convert a current flowing through the readout line Bn into a voltage.

The switches SW may each be coupled to corresponding one of the operational amplifiers OP. The switches SW may each be coupled in parallel to one of the capacitors CP at a location between the negative input terminal T2 and the output terminal T3 of the corresponding one of the operational amplifiers OP. The switches SW may each be switchable between a conducting state and a nonconducting state. For example, in the example embodiment illustrated in FIG. 6, the switch SW1 may be coupled in parallel to the capacitor CP1 at a location between the negative input terminal T2 and the output terminal T3 of the operational amplifier OP1 and switchable between the conducting state and the nonconducting state. Similarly, the switch SW2 may be coupled in parallel to the capacitor CP2 at a location between the negative input terminal T2 and the output terminal T3 of the operational amplifier OP2 and switchable between the conducting state and the nonconducting state. The switch SWn may be coupled in parallel to the capacitor CPn at a location between the negative input terminal T2 and the output terminal T3 of the operational amplifier OPn and switchable between the conducting state and the nonconducting state.

### Measurement Operation of Sensor Apparatus 2

The sensor apparatus 2 may measure the output voltages corresponding to the respective resistors Z in a similar manner to the measurement operation of the sensor apparatus 1 illustrated in FIG. 4 in the measurement environment in which electromagnetic waves, such as infrared rays, are applied to the sensor apparatus 2.

Note, however, that in step S101 in FIG. 4, the switches SW1 to SWn may all be set to the conducting state, the switch SWA1-m corresponding to the power feeding line Am as the correction power feeding line AC, for example, may be set to the conducting state, and the switch SWA2-m may be set to the nonconducting state. Further, the switches SWA1-1, SWA1-2, . . . , and SWA1-m-1 may be set to the nonconducting state, and the switches SWA2-1, SWA2-2, . . . , and SWA2-m-1 may be set to the conducting state. Thereafter, the switches SW1 to SWn may all be switched to the nonconducting state, following which the correction output voltages VCout (1) to VCout (n) may be measured at a point in time when a time T has elapsed. Further, in step S102 in FIG. 4, the switches SW1 to SWn may all be set to the conducting state, the switch SWA1-1 corresponding to the power feeding line A1 as the measurement power feeding line AM, for example, may be set to the conducting state, and the switch SWA2-1 may be set to the nonconducting state. Further, the switches SWA1-2, . . . , and SWA1-m may be set to the nonconducting state, and the switches SWA2-2, . . . , and SWA2-m may be set to the conducting state. Thereafter, the switches SW1 to SWn may all be switched to the nonconducting state, following which the measurement output voltages VMout (1) to VMout (n) may be measured at a point in time when the time T has elapsed.

The output voltage Vout may be expressed by Expression (11) below.

$$Vout = \{ ( V 2 - Vf ) / ( C z \times R z ) \times T + V 2 \qquad ( 11 )$$

where:
Vf is the potential at the node P corresponding to relevant one of the selected resistors ZS;
V2 is a second potential that is the potential at the positive input terminal T1;
Cz is a capacitance value of one capacitor CP coupled to the operational amplifier OP corresponding to the relevant one of the selected resistors ZS;
Rz is the resistance value of the relevant one of the selected resistors ZS;
T is a time that elapses from setting of one switch SW coupled to the operational amplifier OP corresponding to the relevant one of the selected resistors ZS to the nonconducting state; and
Vout is an output voltage from one operational amplifier OP corresponding to the relevant one of the selected resistors ZS after a lapse of the time T.

In step S103 (FIG. 4) of correcting the measured values of the measurement output voltages VMout, based on the measured values of the correction output voltages VCout, the measurement output voltages VMout (1) to VMout (n) respectively corresponding to the resistors ZM (1, 1) to ZM (1, n) coupled to the measurement power feeding line AM (e.g., the power feeding line A1) may be corrected as given by Expressions (2.1) to (2.n) above. Accordingly, the respective resistance values Rz (1, 1) to Rz (1, n) of the resistors ZM (1, 1) to ZM (1, n) may be determined by Equations (12.1) to (12.n) below. Note that Cz (1) to Cz (n) in Equations (12.1) to (12.n) are capacitance values of the capacitors CP1 to Cpn respectively corresponding to the resistors ZM (1, 1) to ZM (1, n).

$$\begin{matrix}R z ( 1 , 1 ) = - \frac{V 1 - V 2}{( VMout ( 1 ) - V 2 ) \times \frac{VCout ( 1 ) - V 2}{VCout ( 1 ) - V 2}} \times \frac{T}{Cz ( 1 )} & ( 12.1 ) \\ R z ( 1 , 2 ) = - \frac{V 1 - V 2}{( VMout ( 2 ) - V 2 ) \times \frac{VCout ( 1 ) - V 2}{VCout ( 2 ) - V 2}} \times \frac{T}{Cz ( 2 )} \\ ⋮ & ( 12.2 ) \\ R z ( 1 , n ) = - \frac{V 1 - V 2}{( VMout ( n ) - V 2 ) \times \frac{VCout ( 1 ) - V 2}{VCout ( n ) - V 2}} \times \frac{T}{Cz ( n )} & ( 12. n )\end{matrix}$$

### Workings and Example Effects of Sensor Apparatus 2

In the sensor apparatus 2 of the example embodiment also, the control circuit 20 corrects the measurement output voltage VMout resulting from at least one of the measurement resistors ZM that are coupled to one measurement power feeding line AM other than the correction power feeding line AC, based on at least two of the correction output voltages VCout (for example, the correction output voltage VCout (1) and a correction output voltage VCout (c), where c is a natural number greater than 1 and smaller than or equal to n) that each result from corresponding one of the correction resistors ZC coupled to the correction power feeding line AC. This helps to mitigate the influence of the wiring resistance of the measurement power feeding line AM on the measurement accuracy for a physical quantity targeted for measurement.

Accordingly, the sensor apparatus 2 of the example embodiment helps to achieve high measurement accuracy for a physical quantity targeted for measurement, such as the intensity of infrared rays or other electromagnetic waves applied to the element array circuit 30.

### 3. Third Example Embodiment

### Overall Configuration Example of Sensor Apparatus 3

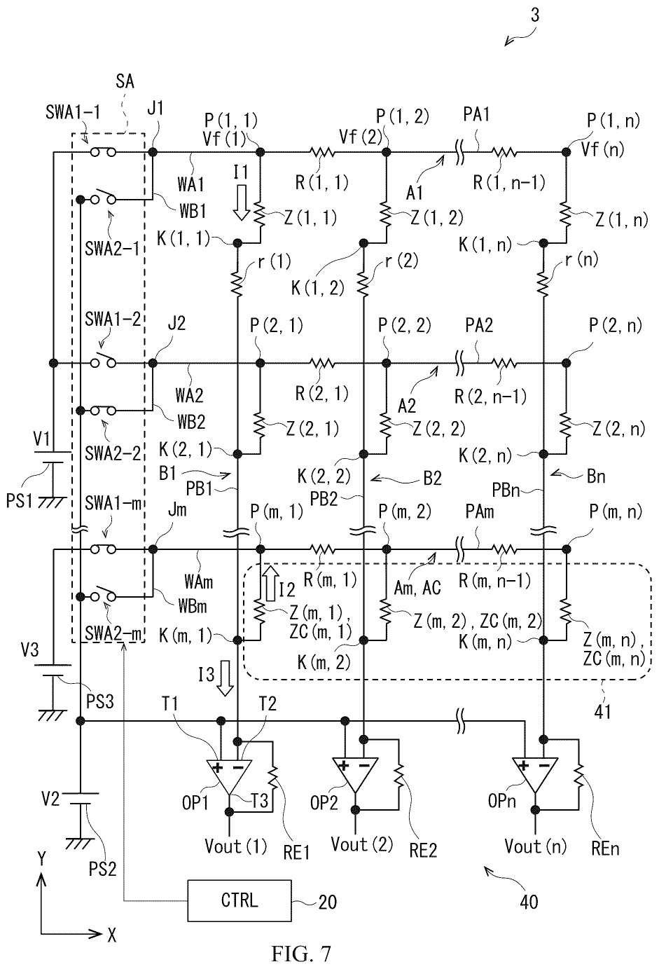

FIG. 7 is a circuit diagram schematically illustrating a configuration example of a sensor apparatus 3 according to a third example embodiment of the disclosure. The sensor apparatus 3 includes an element array circuit 40 and the control circuit 20, for example. In the sensor apparatus 3, the first end of the power feeding line Am as the correction power feeding line AC may be coupled to a direct-current power supply PS3 different from the direct-current power supply PS1. A voltage may be applied to the first end of the power feeding line Am by the direct-current power supply PS3 to cause the first end of the power feeding line Am to be at a third potential V3. Here, a sign of the potential at the first end of the correction power feeding line Am (i.e., the third potential V3) with respect to the potential at the positive input terminal T1 of the operational amplifier OP (i.e., the second potential V2), in other words, a sign of a potential difference between the second potential V2 and the third potential V3, may be opposite to a sign of the potential at the first end of the measurement power feeding line A1 (i.e., the first potential V1) with respect to the potential at the positive input terminal T1 of the operational amplifier OP (i.e., the second potential V2), in other words, a sign of a potential difference between the second potential V2 and the first potential V1. For example, when the potential at the positive input terminal T1 of the operational amplifier OP is 0 V and a voltage is applied from the direct-current power supply PS1 to the power feeding line A1 to set the potential at the first end of the power feeding line A1 as the measurement power feeding line AM to +Vf, a voltage may be applied from the direct-current power supply PS3 to the power feeding line Am to set the potential at the first end of the power feeding line Am as the correction power feeding line AC to −Vf. Note that an absolute value of the potential difference between the potential at the positive input terminal T1 of the operational amplifier OP and the potential at the first end of the power feeding line A1 as the measurement power feeding line AM and an absolute value of the potential difference between the potential at the positive input terminal T1 of the operational amplifier OP and the potential at the first end of the power feeding line Am as the correction power feeding line AC may be different from each other.

Further, in the sensor apparatus 3, an electromagnetic shield 41 may be provided to cover the correction resistors ZC provided along the correction power feeding line AC. Accordingly, in the sensor apparatus 3, the correction resistors ZC may be used as reference devices for correcting measurement errors that depend on an environmental factor around a location where the sensor apparatus 3 is to be placed, such as an environmental temperature. For example, as illustrated in FIG. 7, when a current I1 flows through the resistor Z (1, 1) as the measurement resistor ZM for measuring electromagnetic waves (e.g., infrared rays) targeted for measurement and a current I2 flows through the resistor Z (m, 1) as the correction resistor ZC that also serves as the reference device, a current 13 that is a difference between the current I1 and the current 12 may be inputted to the negative input terminal T2 of the operational amplifier OP1. Here, the resistor Z (1, 1) may have a resistance value reflecting an influence of the environmental temperature and also an influence of the electromagnetic waves being applied; therefore, the current I1 may have a current value reflecting both the influence of the environmental temperature and the influence of the electromagnetic waves. In contrast, the resistor Z (m, 1) may not be influenced by the electromagnetic waves being applied, although influenced by the environmental temperature. Accordingly, the current 12 may have a current value reflecting the influence of the environmental temperature alone, and not reflecting the influence of the electromagnetic waves. The current I3, i.e., the difference between the current I1 and the current 12, may thus have a current value reflecting the influence of the electromagnetic waves alone, with the influence of the environmental temperature being canceled.

### Measurement Operation of Sensor Apparatus 3

The sensor apparatus 3 may also measure the output voltages corresponding to the respective resistors Z in a similar manner to the measurement operation of the sensor apparatus 1 illustrated in FIG. 4 in the measurement environment in which electromagnetic waves, such as infrared rays, are applied to the sensor apparatus 3. Note, however, that in step S102 in FIG. 4, when measuring the measurement output voltages VMout, a voltage may be applied from the direct-current power supply PS1 to the measurement power feeding line A1 with the switch SWA1-m set to the conducting state, the switch SWA2-m set to the nonconducting state, and with a voltage being applied from the direct-current power supply PS3 to the correction power feeding line Am to which the correction resistors ZC (m, 1) to ZC (m, n) that also serve as the reference devices are coupled. In the sensor apparatus 3 also, the measured values of the measurement output voltages VMout may be corrected based on the measured values of the correction output voltages VCout (step S103).

### Workings and Example Effects of Sensor Apparatus 3

In the sensor apparatus 3 of the example embodiment also, the control circuit 20 corrects the measurement output voltage VMout resulting from at least one of the measurement resistors ZM that are coupled to one measurement power feeding line AM other than the correction power feeding line AC, based on at least two of the correction output voltages VCout (for example, the correction output voltage VCout (1) and a correction output voltage VCout (d), where d is a natural number greater than 1 and smaller than or equal to n) that each result from corresponding one of the correction resistors ZC coupled to the correction power feeding line AC. This helps to mitigate the influence of the wiring resistance of the measurement power feeding line AM on the measurement accuracy for a physical quantity targeted for measurement.

Further, in the sensor apparatus 3, the first end of the power feeding line A1 as the measurement power feeding line AM and the first end of the power feeding line Am as the correction power feeding line AC may be configured to be at respective potentials that are opposite in sign with respect to the potential at the positive input terminal T1 of the operational amplifier OP. This helps to allow a measurement error that depends on an environmental factor around the location where the sensor apparatus 3 is placed, such as a measurement error that depends on the environmental temperature, to be corrected by using the correction resistors ZC also as reference devices.

Accordingly, the sensor apparatus 3 of the example embodiment helps to achieve high measurement accuracy for a physical quantity targeted for measurement, such as the intensity of infrared rays or other electromagnetic waves applied to the element array circuit 40.

### 4. Modification Examples

Although some example embodiments of the disclosure have been described hereinabove, the disclosure is not limited to such example embodiments, and may be modified in a variety of ways.

For example, the foregoing descriptions of the sensor apparatuses 1 to 3 of the first to third example embodiments have illustrated an example case where the resistors Z in the element array circuits 10, 30, and 40 may be light-receiving devices that convert electromagnetic waves, such as infrared rays, into an electric signal; however, the sensor apparatus according to an embodiment of the disclosure is not limited thereto.

In some embodiments, a temperature-sensitive resistor element including, for example, a thermistor material or a temperature-sensitive electrically-conductive ink material may be employed as each of the impedance elements of an embodiment of the disclosure. Such a temperature-sensitive resistor element may change in electrical resistance value with changing temperature. In such a case, the sensor apparatus may serve as a temperature sensor configured to measure a temperature distribution in a plane.

In some embodiments, a pressure-sensitive element including, for example, a pressure-sensitive electrically-conductive ink material may be employed as each of the impedance elements of an embodiment of the disclosure. Such a pressure-sensitive element may change in electrical resistance value with changing magnitude of an applied pressure. The sensor apparatus in which the pressure-sensitive elements are used as the impedance elements may serve as a pressure sensor configured to measure a pressure distribution in a plane.

In some embodiments, a strain gauge may be employed as each of the impedance elements of an embodiment of the disclosure. The strain gauge may change in electrical resistance value with changing magnitude of an applied stress. The sensor apparatus in which the strain gauges are used as the impedance elements may serve as a strain sensor configured to measure a stress distribution in a plane.

For example, in the sensor apparatus 1 of the foregoing first example embodiment, among the “m” power feeding lines A1 to Am in the element array circuit 10, the power feeding line Am may be used as the correction power feeding line AC and a power feeding line A other than the power feeding line Am may be used as the measurement power feeding line AM; however, this is non-limiting. In some embodiments, any power feeding line A other than the power feeding line Am among the power feeding lines A1 to Am may be used as the correction power feeding line AC.

Further, for example, respective illustrations of the sensor apparatuses 1 to 3 of the foregoing first to third example embodiments in the drawings each exemplify a case in which the first wirings extend in directions parallel to each other; however, embodiments of the disclosure are not limited thereto. In some embodiments, the first wirings may be non-parallel to each other. Further, each of the first wirings does not have to extend linearly, and may extend in a curved shape as a whole, or may be shaped to include a curved portion or a bent portion. Similarly, the respective illustrations of the sensor apparatuses 1 to 3 of the foregoing first to third example embodiments in the drawings each exemplify a case in which the second wirings extend in directions parallel to each other; however, embodiments of the disclosure are not limited thereto. In some embodiments, the second wirings may be non-parallel to each other. Further, embodiments of the disclosure are not limited to a case in which the first wirings and the second wirings extend in directions orthogonal to each other. Moreover, each of the second wirings does not have to extend linearly, and may extend in a curved shape as a whole, or may be shaped to include a curved portion or a bent portion.

Further, the sensor apparatuses 1 to 3 of the foregoing first to third example embodiments may each include the resistors as the impedance elements; however, the sensor apparatus according to an embodiment of the disclosure is not limited thereto. In some embodiments, the sensor apparatus may include semiconductor elements. The semiconductor elements may have an electrical property that changes with temperature, for example. Non-limiting examples of such semiconductor elements may include a diode. Further, the sensor apparatuses 1 to 3 of the foregoing first to third example embodiments may each include the multiple operational amplifiers; however, the sensor apparatus according to an embodiment of the disclosure is not limited thereto. In some embodiments, the sensor apparatus may include a single operational amplifier, and the readout lines B to be coupled to the output terminal T3 of the single operational amplifier OP may be switched by a switch.

The disclosure encompasses any possible combination of some or all of the various embodiments and the modification examples described herein and incorporated herein. It is possible to achieve at least the following configurations from the foregoing example embodiments and modification examples of the disclosure.

(1)

A sensor apparatus including:
an element array circuit, the element array circuit including
   first wirings,
   second wirings each extending in a direction different from a direction in which the first wirings each extend, and
   impedance elements each coupled to both one of the first wirings and one of the second wirings; and
a control circuit configured to, based on at least two of output voltages each resulting from corresponding one of correction impedance elements, among the impedance elements, that are coupled to one first correction wiring selected from the first wirings, correct an output voltage resulting from at least one of measurement impedance elements, among the impedance elements, that are coupled to one first measurement wiring that is selected from the first wirings and other than the first correction wiring.
   (2)

The sensor apparatus according to (1), in which
the first wirings each include a first end and a second end, the first end being coupled to a power supply or a ground, the second end being positioned on an opposite side from the power supply or the ground with respect to the first end, and
the control circuit is configured to correct, as the output voltage resulting from the at least one of the measurement impedance elements, an output voltage resulting from an r-th measurement impedance element from the first end of the first measurement wiring, among the measurement impedance elements that are coupled to the first measurement wiring, based on a ratio between a first output voltage and a second output voltage as the at least two of the output voltages each resulting from corresponding one of the correction impedance elements, the first output voltage being an output voltage resulting from a q-th correction impedance element from the first end of the first correction wiring, among the correction impedance elements that are coupled to the first correction wiring, the second output voltage being an output voltage resulting from an r-th correction impedance element from the first end of the first correction wiring, among the correction impedance elements that are coupled to the first correction wiring, where q is a natural number, and r is a natural number greater than q.
   (3)

The sensor apparatus according to (2), in which the q is 1.

(4)

The sensor apparatus according to (1), further including an electromagnetic shield covering the correction impedance elements.

(5)

The sensor apparatus according to (4), in which
the element array circuit further includes one or more operational amplifiers each including one positive input terminal to be set to a first potential and one negative input terminal couplable to one of the second wirings,
the first wirings each include a first end and a second end, the first end being coupled to a power supply or a ground, the second end being positioned on an opposite side from the power supply or the ground with respect to the first end, and
the first end of the first measurement wiring and the first end of the first correction wiring are configured to be at respective potentials that are opposite in sign with respect to the first potential.

In the sensor apparatus according to at least one embodiment of the disclosure, the control circuit corrects the output voltage resulting from at least one of the measurement impedance elements, based on at least two of the output voltages each resulting from corresponding one of the correction impedance elements. This mitigates the influence of the wiring resistance of each of the first wirings on measurement accuracy.

The sensor apparatus according to at least one embodiment of the disclosure makes it possible to achieve high measurement accuracy for a physical quantity targeted for measurement.

It is to be noted that the effects described herein are mere examples and non-limiting, and other effects may be achieved.

Although the disclosure has been described hereinabove in terms of the example embodiment and modification examples, the disclosure is not limited thereto. It should be appreciated that variations may be made in the described example embodiment and modification examples by those skilled in the art without departing from the scope of the disclosure as defined by the following claims.

The limitations in the claims are to be interpreted broadly based on the language employed in the claims and not limited to examples described in this specification or during the prosecution of the application, and the examples are to be construed as non-exclusive.

As used in this specification and the appended claims, the singular forms “a,” “an,” and “the” include, especially in the context of the claims, are to be construed to cover both the singular and the plural, unless otherwise indicated herein or clearly contradicted by context.

Throughout this specification and the appended claims, unless the context requires otherwise, the terms “comprise”, “include”, “have”, and their variations are to be construed to cover the inclusion of a stated element, integer or step but not the exclusion of any other non-stated element, integer or step.

The use of the terms first, second, etc. do not denote any order or importance, but rather the terms first, second, etc. are used to distinguish one element from another.

The term “substantially”, “approximately”, “about”, and its variants having the similar meaning thereto are defined as being largely but not necessarily wholly what is specified as understood by one of ordinary skill in the art.

The term “disposed on/provided on/formed on” and its variants having the similar meaning thereto as used herein refer to elements disposed directly in contact with each other or indirectly by having intervening structures therebetween.

What is claimed is:

1. A sensor apparatus comprising:
an element array circuit, the element array circuit including:
first wirings,
second wirings each extending in a direction different from a direction in which the first wirings each extend, and
impedance elements each coupled to both one of the first wirings and one of the second wirings; and
a control circuit configured to, based on at least two of output voltages each resulting from corresponding one of correction impedance elements, among the impedance elements, that are coupled to one first correction wiring selected from the first wirings, correct an output voltage resulting from at least one of measurement impedance elements, among the impedance elements, that are coupled to one first measurement wiring that is selected from the first wirings and other than the first correction wiring.

2. The sensor apparatus according to claim 1, wherein
the first wirings each include a first end and a second end, the first end being coupled to a power supply or a ground, the second end being positioned on an opposite side from the power supply or the ground with respect to the first end, and
the control circuit is configured to correct, as the output voltage resulting from the at least one of the measurement impedance elements, an output voltage resulting from an r-th measurement impedance element from the first end of the first measurement wiring, among the measurement impedance elements that are coupled to the first measurement wiring, based on a ratio between a first output voltage and a second output voltage as the at least two of the output voltages each resulting from corresponding one of the correction impedance elements, the first output voltage being an output voltage resulting from a q-th correction impedance element from the first end of the first correction wiring, among the correction impedance elements that are coupled to the first correction wiring, the second output voltage being an output voltage resulting from an r-th correction impedance element from the first end of the first correction wiring, among the correction impedance elements that are coupled to the first correction wiring, where q is a natural number, and r is a natural number greater than q.

3. The sensor apparatus according to claim 2, wherein the q is 1.

4. The sensor apparatus according to claim 1, further comprising an electromagnetic shield covering the correction impedance elements.

5. The sensor apparatus according to claim 4, wherein
the element array circuit further includes one or more operational amplifiers each including one positive input terminal to be set to a first potential and one negative input terminal couplable to one of the second wirings,
the first wirings each include a first end and a second end, the first end being coupled to a power supply or a ground, the second end being positioned on an opposite side from the power supply or the ground with respect to the first end, and
the first end of the first measurement wiring and the first end of the first correction wiring are configured to be at respective potentials that are opposite in sign with respect to the first potential.
